(19) United States
(12) Patent Application Publication
(10) Pub. No.: US 2024/0326404 A1
(43) Pub. Date: Oct. 3, 2024

(54) SCREEN COATING JIG AND SEALING STRUCTURE OF PLATE-SHAPED MEMBER

(71) Applicant: Honda Motor Co., Ltd., Tokyo (JP)

(72) Inventors: Tetsuya Sugano, Tokyo (JP); Fumiya Sato, Tokyo (JP)

(21) Appl. No.: 18/588,160

(22) Filed: Feb. 27, 2024

(30) Foreign Application Priority Data
Mar. 31, 2023 (JP) 2023-057478

(51) Int. Cl. B41F 15/38; B41F 15/36; H01M 8/0273; H01M 8/10

(52) U.S. Cl. CPC B41F 15/38; B41F 15/36; H01M 8/0273; H01M 2008/1095

(57) ABSTRACT

Screen coating jig for screen-coating surface of plate-shaped member having protrusion to cross protrusion with sealing member, including: jig body having higher rigidity than sealing member to be placed on surface of plate-shaped member. Jig body includes: first surface facing surface of plate-shaped member; second surface on opposite side of first surface; and pair of dividing surfaces extending from first surface to second surface and dividing at least part of jig body into first portion and second portion. First surface includes recess to be fitted to protrusion of plate-shaped member starting from intersection portions with pair of dividing surfaces. Pair of dividing surfaces has uniform height from first surface to second surface. Width between pair of dividing surfaces is narrowed at position corresponding to recess.

### CROSS-REFERENCE TO RELATED APPLICATION

This application is based upon and claims the benefit of priority from Japanese Patent Application No. 2023-057478 filed on Mar. 31, 2023, the content of which is incorporated herein by reference.

### BACKGROUND OF THE INVENTION

### Field of the Invention

The present invention relates to a screen coating jig for screen-coating a plate-shaped member with a sealing member, and a sealing structure of the plate-shaped member.

### Description of the Related Art

In the related art, there has been known a jig for screen-coating, with a paste-like member, a plate material provided in an uneven shape such as a separator of a fuel cell. For example, in a jig described in JP 2017-087504 A, fitting recesses and protrusions that can be fitted into recesses and protrusions formed in an application target member are formed on a surface facing the application target member in a mask integrally provided on a screen, and a paste application opening is opened in at least one of the fitting protrusion and the fitting recess in the fitting recesses and protrusions.

Meanwhile, when a sealed space is formed facing a plate material provided in an uneven shape, a sealing member crossing a surface of the plate material may be formed. In such a case, it is preferable to make a height of the sealing member uniform in order to secure sealing properties. However, J P 2017-087504 A does not describe this point at all.

### SUMMARY OF THE INVENTION

An aspect of the present invention is a screen coating jig for screen-coating a surface of a plate-shaped member having a protrusion to cross the protrusion with a sealing member, including: a jig body having higher rigidity than the sealing member to be placed on the surface of the plate-shaped member. The jig body includes: a first surface facing the surface of the plate-shaped member; a second surface on an opposite side of the first surface; and a pair of dividing surfaces extending from the first surface to the second surface and dividing at least a part of the jig body into a first portion and a second portion. The first surface includes a recess to be fitted to the protrusion of the plate-shaped member starting from intersection portions with the pair of dividing surfaces. The pair of dividing surfaces has a uniform height from the first surface to the second surface. A width between the pair of dividing surfaces is narrowed at a position corresponding to the recess.

Another aspect of the present invention is a sealing structure of a plate-shaped member, including: a plate-shaped member having a protrusion; and a sealing member provided on a surface of the plate-shaped member to cross the protrusion. The sealing member has a uniform height from the surface of the plate-shaped member. A width of the sealing member is narrowed at a position where the sealing member crosses the protrusion.

### BRIEF DESCRIPTION OF THE DRAWINGS

The objects, features, and advantages of the present invention will become clearer from the following description of embodiments in relation to the attached drawings, in which:

FIG. 1 is a perspective view schematically illustrating an overall configuration of a fuel cell stack having a sealing structure of a plate-shaped member according to an embodiment of the present invention;

FIG. 2 is a perspective view illustrating a schematic configuration of an electrode assembly included in the fuel cell stack of FIG. 1;

FIG. 3 is a cross-sectional view of a power generation cell 1 of FIG. 1 taken along line III-III;

FIG. 4 is a front view illustrating an example of the sealing structure in the vicinity of a through-hole of a separator of FIG. 3;

FIG. 5 is a front view illustrating an example of a screen coating jig according to a first embodiment of the present invention;

FIG. 6 is a cross-sectional view taken along line VI-VI of FIG. 5;

FIG. 7 is a perspective view partially illustrating the screen coating jig of FIG. 5;

FIG. 8 is a cross-sectional view of a sealing member 7 coated on the surface of the separator 3, and FIG. 9 is a diagram for describing characteristics (thixotropic characteristics) of the resin material constituting the sealing member of FIG. 4;

FIG. 9 is a diagram for describing characteristics of resin material constituting the sealing member of FIG. 4;

FIG. 10 is a cross-sectional view of the sealing member coated by the screen coating jig of FIG. 5;

FIG. 11 is a perspective view of the sealing member coated by the screen coating jig of FIG. 5;

FIG. 12 is a perspective view partially illustrating a screen coating jig according to a second embodiment of the present invention;

FIG. 13 is a cross-sectional view of the sealing member coated by the screen coating jig of FIG. 12;

FIG. 14 is a perspective view of the sealing member coated by the screen coating jig of FIG. 12; and

FIG. 15 is a front view illustrating an example of the sealing structure of the plate-shaped member according to the second embodiment of the present invention.

### DETAILED DESCRIPTION OF THE INVENTION

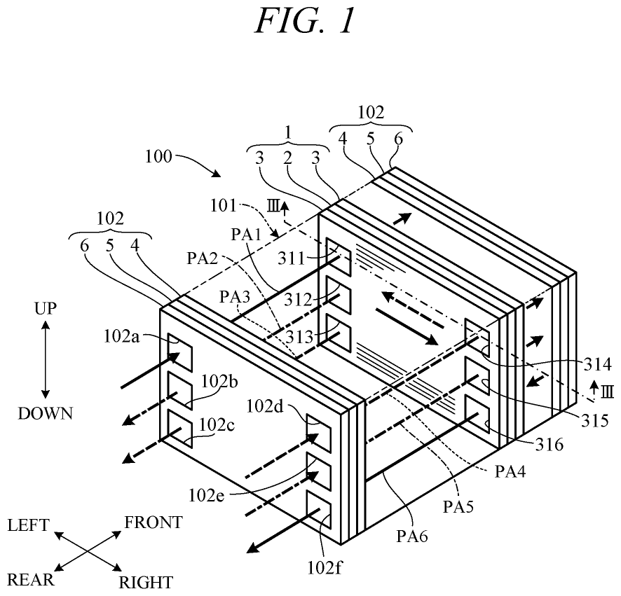

Hereinafter, embodiments of the present invention will be described with reference to FIGS. 1 to 15. A screen coating jig according to the embodiments of the present invention is a jig for screen-coating, with a sealing member, a surface of a plate-shaped member having a protrusion to cross the protrusion, and is, for example, a jig for screen-coating, with a sealing member, a separator of a fuel cell provided in an uneven shape. A sealing structure of a plate-shaped member according to the embodiments of the present invention is a sealing structure provided on a surface of the plate-shaped member having a protrusion to cross the protrusion, and is, for example, a sealing structure provided on a surface of a separator of a fuel cell provided in an uneven shape. The fuel cell is mounted on, for example, a vehicle and can generate electric power for driving the vehicle. First, an overall configuration of a fuel cell stack that is a component of the fuel cell will be schematically described.

FIG. 1 is a perspective view schematically illustrating an overall configuration of a fuel cell stack 100 having a sealing structure of a plate-shaped member according to the embodiments of the present invention. Hereinafter, for the sake of convenience, three-axis directions orthogonal to each other as illustrated in the drawing are defined as a front-rear direction, a left-right direction, and an up-down direction, and a configuration of each unit will be described according to such definitions. These directions are not necessarily identical to a front-rear direction, a left-right direction, and an up-down direction of the vehicle. For example, the front-rear direction in FIG. 1 may be the front-rear direction, the left-right direction, or the up-down direction of the vehicle.

As illustrated in FIG. 1, the fuel cell stack 100 includes a cell stacked body 101 formed by stacking a plurality of power generation cells 1 in the front-rear direction, and end units 102 arranged at both front and rear end portions of the cell stacked body 101, and has a substantially rectangular parallelepiped shape as a whole. A length of the cell stacked body 101 in the left-right direction is longer than a length in the up-down direction. In FIG. 1, a single power generation cell 1 is illustrated for the sake of convenience. The power generation cell 1 includes an electrode assembly 2 having a joint body including an electrolyte membrane and an electrode, and separators 3 and 3 that are arranged on both front and rear sides of the electrode assembly 2 and sandwich the electrode assembly 2. The electrode assembly 2 and the separators 3 are alternately arranged in the front-rear direction.

The separator 3 includes a pair of front and rear metal thin plates having a corrugated cross section, and is integrally formed by joining outer peripheries of the thin plates. For the separator 3, a conductive material having excellent corrosion resistance is used, and for example, titanium, a titanium alloy, stainless steel, or the like can be used. A cooling flow path through which a cooling medium flows is formed inside the separator 3, and a power generation surface of the power generation cell 1 is cooled by the flow of the cooling medium. For example, water can be used as the cooling medium. Surfaces (front surface and rear surface) of the separators 3 facing the electrode assembly 2 are formed in an uneven shape by press-molding or the like to form gas flow paths between the separators and the electrode assembly 2.

The separator 3 on the front side of the electrode assembly 2 is, for example, a separator on an anode side (anode separator), and an anode flow path through which a fuel gas flows is formed between the anode separator 3 and the joint body of the electrode assembly 2. The separator 3 on the rear side of the electrode assembly 2 is, for example, a separator on a cathode side (cathode separator), and a cathode flow path through which an oxidant gas flows is formed between the cathode separator 3 and the joint body of the electrode assembly 2. For example, a hydrogen gas can be used as the fuel gas, and for example, air can be used as the oxidant gas. The fuel gas and the oxidant gas may be referred to as a reaction gas without being distinguished from each other.

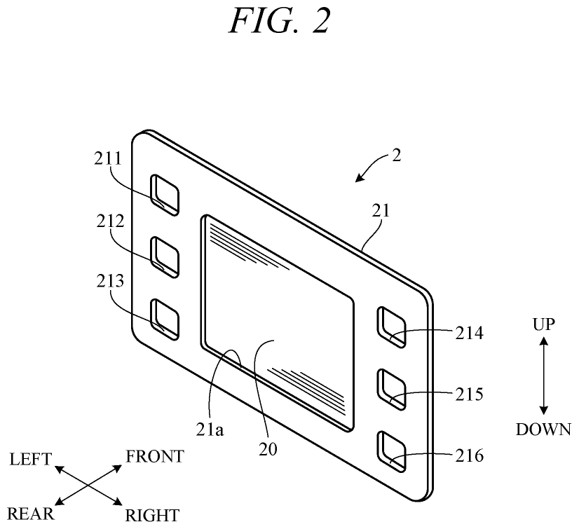

FIG. 2 is a perspective view illustrating a schematic configuration of the electrode assembly 2. As illustrated in FIG. 2, the electrode assembly 2 includes a substantially rectangular joint body 20 and a frame 21 that supports the joint body 20. The joint body 20 is a membrane electrode joint body (so-called membrane electrode assembly (MEA)), and has an electrolyte membrane, an anode electrode provided on a front surface of the electrolyte membrane, and a cathode electrode provided on a rear surface of the electrolyte membrane.

The electrolyte membrane is, for example, a solid polymer electrolyte membrane, and a thin film of perfluorosulfonic acid containing moisture can be used. Not only a fluorine-based electrolyte but also a hydrocarbon-based electrolyte can be used.

The anode electrode is an electrode catalyst layer that is formed on the front surface of the electrolyte membrane and serves as a reaction field of an electrode reaction, and a gas diffusion layer that diffuses and supplies a reaction gas is provided on the front surface of the electrode catalyst layer. The cathode electrode is an electrode catalyst layer that is formed on the rear surface of the electrolyte membrane and serves as a reaction field of an electrode reaction, and a gas diffusion layer that diffuses and supplies a reaction gas is provided on the rear surface of the electrode catalyst layer. The electrode catalyst layer includes a catalytic metal that promotes an electrochemical reaction between hydrogen contained in the fuel gas and oxygen contained in the oxidant gas, an electrolyte having proton conductivity, carbon particles having electron conductivity, and the like. The gas diffusion layer is made of a conductive member having gas permeability, for example, a carbon porous body.

In the anode electrode, the fuel gas (hydrogen) supplied through the anode flow path and the gas diffusion layer is ionized by an action of a catalyst, passes through the electrolyte membrane, and moves to the cathode electrode side. Electrons generated at this time pass through an external circuit and are extracted as electric energy. In the cathode electrode, an oxidant gas (oxygen) supplied via the cathode flow path and the gas diffusion layer reacts with hydrogen ions guided from the anode electrode and electrons moved from the anode electrode to generate water. The generated water gives an appropriate humidity to the electrolyte membrane, and excess water is discharged to the outside of the electrode assembly 2.

The frame 21 is a thin plate having a substantially rectangular shape, and is made of an insulating resin, rubber, or the like. A substantially rectangular opening portion 21a is provided in a central portion of the frame 21, and the joint body 20 is provided to cover the entire opening portion 21a. Three through-holes 211 to 213 penetrating the frame 21 in the front-rear direction are opened in a line in the up-down direction on a left side of the opening portion 21a of the frame 21, and three through-holes 214 to 216 penetrating the frame 21 in the front-rear direction are opened in a line in the up-down direction on a right side of the opening portion 21a.

As illustrated in FIG. 1, through-holes 311 to 316 penetrating the separators 3 in the front-rear direction are opened in the separators 3 on the front and rear sides of the electrode assembly 2 at positions corresponding to the through-holes 211 to 216 of the frame 21. The through-holes 311 to 316 communicate with the through-holes 211 to 216 of the frame 21, respectively. The sets of the through-holes 211 to 216 and 311 to 316 communicating with each other form flow paths PA1 to PA6 (indicated by arrows for the sake of convenience) penetrating the cell stacked body 101 and extending in the front-rear direction. The flow paths PA1 to PA6 may be referred to as manifolds. The flow paths PA1 to PA6 are connected to a manifold outside the fuel cell stack 100.

The flow path PA1 (solid arrow) extending forward via the through-holes 211 and 311 is a fuel gas supply flow path. The flow path PA6 (solid arrow) extending rearward via the through-holes 216 and 316 is a fuel gas discharge flow path. The fuel gas supply flow path PA1 and the fuel gas discharge flow path PA6 communicate with the anode flow path facing the front surface of the joint body 20, and as indicated by the solid arrows, the fuel gas flows through the anode flow path in the left-right direction via the fuel gas supply flow path PA1 and the fuel gas discharge flow path PA6. The communication between the anode flow path and the other flow paths PA2 to PA5 is blocked via a sealing member 7 (FIG. 3). The fuel gas flowing through the fuel gas discharge flow path PA6 is a fuel gas a part of which has been used in the anode electrode, and may be referred to as a fuel exhaust gas.

The flow path PA4 (dotted arrow) extending forward via the through-holes 214 and 314 is an oxidant gas supply flow path. The flow path PA3 (dotted arrow) extending rearward via the through-holes 213 and 313 is an oxidant gas discharge flow path. The oxidant gas supply flow path PA4 and the oxidant gas discharge flow path PA3 communicate with the cathode flow path facing the rear surface of the joint body 20, and as indicated by the dotted arrows, the oxidant gas flows through the cathode flow path in the left-right direction via the oxidant gas supply flow path PA4 and the oxidant gas discharge flow path PA3. The communication between the cathode flow path and the other flow paths PA1, PA2, PA5, and PA6 is blocked via the sealing member 7 (FIG. 3). The oxidant gas flowing through the oxidant gas discharge flow path PA3 is an oxidant gas a part of which has been used in the cathode electrode, and may be referred to as oxidant exhaust gas. The fuel exhaust gas and the oxidant exhaust gas may be referred to as a reaction exhaust gas without being distinguished from each other.

The flow path PA5 (dashed-dotted line arrow) extending forward via the through-holes 215 and 315 is a cooling medium supply flow path. The flow path PA2 (dashed-dotted line arrow) extending rearward via the through-holes 212 and 312 is a cooling medium discharge flow path. The cooling medium supply flow path PA5 and the cooling medium discharge flow path PA2 communicate with the cooling flow path inside the separator 3, and the cooling medium flows through the cooling flow path via the cooling medium supply flow path PA5 and the cooling medium discharge flow path PA2. The communication between the cooling flow path and the other flow paths PA1, PA3, PA4, and PA6 is blocked via the sealing member 7 (FIG. 3).

Each of the end units 102 arranged on both the front and rear sides of the cell stacked body 101 includes a terminal plate 4, an insulating plate 5, and an end plate 6. Note that the end unit 102 on the front side may be referred to as a dry-side end unit, and the end unit 102 on the rear side may be referred to as a wet-side end unit. The pair of front and rear terminal plates 4 and 4 is arranged on both front and rear sides of the cell stacked body 101 with the cell stacked body interposed therebetween. The pair of front and rear insulating plates 5 and 5 is arranged on both front and rear sides of the terminal plates 4 and 4 with the terminal plates interposed therebetween. The pair of front and rear end plates 6 and 6 is arranged on both front and rear sides of the insulating plates 5 and 5 with the insulating plates interposed therebetween.

The terminal plate 4 is a substantially rectangular plate-shaped member made of metal, and has a terminal portion for extracting electric power generated by an electrochemical reaction in the cell stacked body 101. The insulating plate 5 is a substantially rectangular plate-shaped member made of non-conductive resin or rubber, and electrically insulates the terminal plate 4 from the end plate 6. The end plate 6 is a plate-shaped member made of metal or resin having high strength, and for example, a coupling member elongated in the front-rear direction and coupling the front and rear end plates 6 and 6 to each other is fixed to the end plate 6 with a bolt. The fuel cell stack 100 is held in a state of being pressed in the front-rear direction by the end plates 6 and 6 via the coupling member. A case surrounding the cell stacked body 101 may be used as the coupling member, and the end plates 6 and 6 may be fixed to a front end surface and a rear end surface of the case, respectively.

A plurality of through-holes 102a to 102f penetrating the end unit 102 in the front-rear direction are opened in the end unit 102 on the rear side. Note that each of the through-holes 102a to 102f includes a through-hole penetrating the terminal plate 4, a through-hole penetrating the insulating plate 5, and a through-hole penetrating the end plate 6, but, in FIG. 1, these through-holes are collectively referred to as through-holes 102a to 102f for the sake of convenience. The through-hole 102a is opened on an extension line of the fuel gas supply flow path PA1 to communicate with the fuel gas supply flow path PA1. The through-hole 102b is opened on an extension line of the cooling medium discharge flow path PA2 to communicate with the cooling medium discharge flow path PA2. The through-hole 102c is opened on an extension line of the oxidant gas discharge flow path PA3 to communicate with the oxidant gas discharge flow path PA3. The through-hole 102d is opened on an extension line of the oxidant gas supply flow path PA4 to communicate with the oxidant gas supply flow path PA4. The through-hole 102e is opened on an extension line of the cooling medium supply flow path PA5 to communicate with the cooling medium supply flow path PA5. The through-hole 102f is opened on an extension line of the fuel gas discharge flow path PA6 to communicate with the fuel gas discharge flow path PA6.

More specifically, a fuel gas tank storing a high-pressure fuel gas is connected to the through-hole 102a via an ejector, an injector, or the like, and the fuel gas in the fuel gas tank is supplied to the fuel cell stack 100 via the through-hole 102a. A gas-liquid separator is connected to the through-hole 102f, and a fuel gas (fuel exhaust gas) discharged via the through-hole 102f is separated into a fuel gas and water by the gas-liquid separator. The separated fuel gas is sucked via the ejector and is supplied to the fuel cell stack 100 again. The separated water is discharged to the outside via a drain flow path.

A compressor for supplying the oxidant gas is connected to the through-hole 102d, and the oxidant gas compressed by the compressor is supplied to the fuel cell stack 100 via the through-hole 102d. The oxidant gas (oxidant exhaust gas) flows to the outside from the through-hole 102c. A pump for supplying the cooling medium is connected to the through-hole 102e, and the cooling medium is supplied to the fuel cell stack 100 via the through-hole 102e. The cooling medium is discharged from the through-hole 102b. The discharged cooling medium is cooled by heat exchange in a radiator, and is supplied to the fuel cell stack 100 again via the through-hole 102e.

A schematic configuration of the fuel cell stack 100 has been described above. The fuel cell stack 100 is housed in a substantially box-shaped case and is mounted on the vehicle.

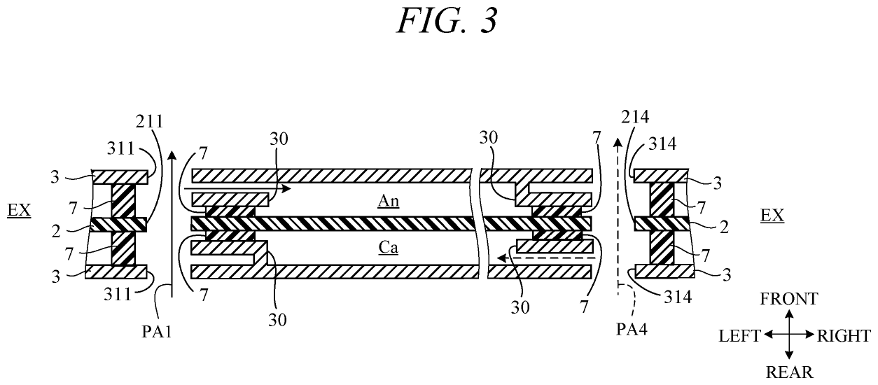

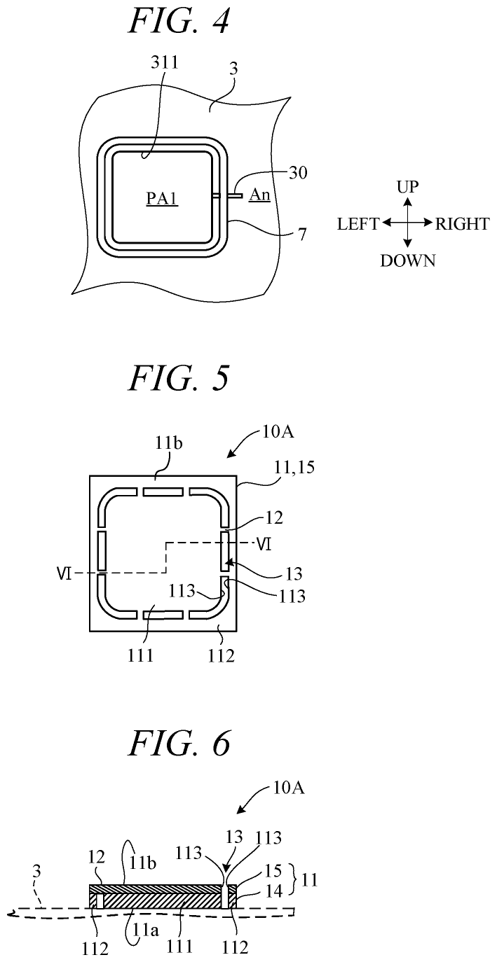

FIG. 3 is a cross-sectional view of the power generation cell 1 of FIG. 1 taken along line III-III. As illustrated in FIG. 3, an anode flow path An is formed between the anode separator 3 on the front side and the electrode assembly 2 (joint body 20), and a cathode flow path Ca is formed between the cathode separator 3 on the rear side and the electrode assembly 2 (joint body 20). FIG. 4 is a front view illustrating an example of the sealing structure in the vicinity of the through-hole 311 (fuel gas supply flow path PA1) of the separator (anode separator) 3, and illustrates a surface (rear surface) in the vicinity of the through-hole 311 of the separator 3 facing the electrode assembly 2 (frame 21).

As illustrated in FIGS. 3 and 4, a plurality of protrusions 30 having a semi-cylindrical shape (only one protrusion is illustrated in the drawing) forming a communication path that allows communication between the through-holes 311 and 314 (reaction gas supply flow paths PA1 and PA4) and the gas flow paths An and Ca are provided on the surface of the separator 3 facing the electrode assembly 2. Among these communication paths, a communication path that allows communication between the fuel gas supply flow path PA1 and the cathode flow path Ca and a communication path that allows communication between the oxidant gas supply flow path PA4 and the anode flow path An are closed.

The sealing member 7 is provided on the surface of the separator 3 to cross the protrusions 30 and surround the through-holes 311 and 314. As the sealing member 7, a resin material such as a thermosetting elastomer such as silicon, urethane, or fluorine, a thermoplastic elastomer, synthetic rubber, or natural rubber can be used. A distal end of the sealing member 7 provided on the surface of the separator 3 is in close contact with the electrode assembly 2 (frame 21), whereby the reaction gas supply flow paths PA1 and PA4 are blocked (sealed) from an external space EX and the gas flow paths Ca and An not communicating with the reaction gas supply flow paths.

More specifically, when the fuel cell stack 100 in FIG. 1 is pressed in the front-rear direction by the end plates 6 and 6 via the coupling member, a compressive load in the front-rear direction is applied to the sealing member 7, the sealing member 7 is pressed to be elastically deformed, and the distal end of the sealing member 7 is brought into close contact with the electrode assembly 2 (frame 21). At this time, the surface pressure is applied to the distal end of the sealing member 7 by the compressive load, whereby the sealed state of the reaction gas supply flow paths PA1 and PA4 is secured.

As described above, in a case where the sealed space is formed to face the plate-shaped member such as the separator 3 having the protrusion 30, it is preferable to make the height of the sealing member 7 uniform in order to secure the sealing properties. Therefore, in the present embodiment, a screen coating jig is configured as follows such that it is possible to screen-coat the surface of the separator 3 having the protrusion 30 with the sealing member 7 crossing the protrusion 30 and having a uniform height.

### First Embodiment

FIG. 5 is a front view illustrating an example of a screen coating jig (hereinafter, jig) 10A according to a first embodiment of the present invention, and FIG. 6 is a cross-sectional view taken along line VI-VI of FIG. 5. As illustrated in FIGS. 5 and 6, the jig 10A includes a jig body 11 placed on the surface of the separator 3 to be a coating surface, and a connection portion 12 that connects a first portion 111 and a second portion 112 of the jig body 11.

The jig body 11 and the connection portion 12 are made of a member having higher rigidity than that of the sealing member 7. For example, metal such as stainless steel can be used for the jig body 11 and the connection portion 12. A material obtained by applying a water-repellent treatment to a resin such as Teflon (registered trademark) or silicon may be used for the jig body 11 and the connection portion 12. The width of the connection portion 12 is set to a sufficiently small value (for example, about 100 μm) in consideration of the material of the sealing member 7 so as not to cause a step on the surface of the sealing member 7 after coating.

The jig body 11 has a first surface 11a facing the surface of the separator 3, a second surface 11b on a side opposite to the first surface 11a, and a pair of dividing surfaces 113 and 113 that extends from the first surface 11a to the second surface 11b and divides the jig body 11 into the first portion 111 and the second portion 112. In the example of FIG. 5, the pair of dividing surfaces 113 and 113 is provided in an annular shape, and completely divides the jig body 11 into the first portion 111 on the inner side surrounded by the pair of dividing surfaces 113 and 113 and the second portion 112 on the outer side. The pair of dividing surfaces 113 and 113 may be provided in a line segment shape or a curved line shape to partially divide the jig body 11 into the first portion 111 and the second portion 112. In this case, the jig 10A may be configured only with the jig body 11 without providing the connection portion 12 connecting the first portion 111 and the second portion 112. Hereinafter, a space between the first portion 111 and the second portion 112, in other words, a space between the first surface 11a and the second surface 11b and between the pair of dividing surfaces 113 and 113 is referred to as a groove portion 13.

The jig body 11 is formed, for example, by molding a lower layer 14 including the first surface 11a and an upper layer 15 including the second surface 11b separately and joining the lower layer 14 and the upper layer 15. In this case, the lower layer 14 includes the first portion 111 and the second portion 112, and the upper layer 15 includes the first portion 111, the second portion 112, and the connection portion 12. The jig body 11 and the connection portion 12 may be integrally molded, and subjected to processing such as etching processing or milling processing so that the jig body 11 is divided into the first portion 111 and the second portion 112 and the connection portion 12 is formed.

FIG. 7 is a perspective view partially illustrating the jig 10A, and schematically illustrates a state in which the surface of the separator 3 having the protrusion 30 to cross the protrusion 30 is screen-coated with the sealing member 7 by the jig 10A. As illustrated in FIG. 7, in the screen coating, first, the jig 10A is placed on the surface of the separator 3 to be the coating surface such that the first surface 11a of the jig body 11 faces the surface of the separator 3 having the protrusion 30. Next, a paste P of a resin material such as a thermosetting elastomer such as silicon, urethane, or fluorine having thixotropy, a thermoplastic elastomer, synthetic rubber, or natural rubber is placed on the second surface 11b of the jig body 11. Then, the paste P is pressed against the second surface 11b around the groove portion 13 by a squeegee 16, the squeegee 16 is slid to apply the paste P on the surface of the separator 3 via the groove portion 13, and the paste P is cured, thereby applying and forming the sealing member 7 on the surface of the separator 3. Such screen coating may be performed manually, or may be automatically performed using a screen printing apparatus including a mounting table where the separator 3 is fixed, the jig 10A, and the squeegee 16.

The first surface 11a of the jig body 11 has a pair of recesses 115 and 115 fitted to the protrusions 30 of the separator 3 starting from intersection portions 114 and 114 with the pair of dividing surfaces 113 and 113. One of the pair of recesses 115 and 115 is provided in the first portion 111 of the jig body 11, and the other is provided in the second portion 112 of the jig body 11. In a case where the jig body 11 is made of metal, a material obtained by applying a water-repellent treatment to a resin such as Teflon (registered trademark) or silicon may be used only for the recess 115.

Since the recess 115 fitted to the protrusion 30 on the surface of the separator 3 is provided in the first surface 11a of the jig body 11 facing the coating surface, it is possible to regulate the displacement of the jig body 11 with respect to the coating surface even in a case where a pressing force is applied to the jig 10A in the sliding direction of the squeegee 16 during the coating. Thus, screen coating can be accurately performed on the surface of the separator 3.

As described above, by performing the screen coating using the jig body 11 having relatively higher rigidity than that of the sealing member 7 and the squeegee 16, it is possible to prevent the sealing member 7 from being applied to the outside of the groove portion 13 and to coat and form the sealing member 7 having a shape conforming to the shape of the groove portion 13.

The jig body 11 is formed such that the depth of the groove portion 13, that is, a height h1 of the pair of dividing surfaces 113 and 113 is uniform from the first surface 11a to the second surface 11b. Therefore, the height of the sealing member 7 applied and formed along the shape of the groove portion 13 defined by the pair of dividing surfaces 113 and 113, the first surface 11a (surface of the separator 3), and the second surface 11b (squeegee 16) of the jig body 11 can be made substantially uniform.

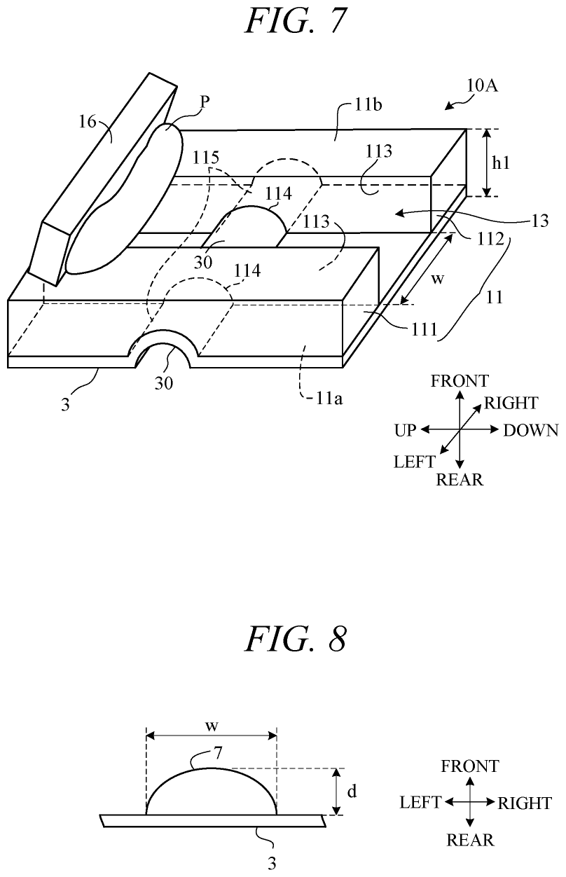

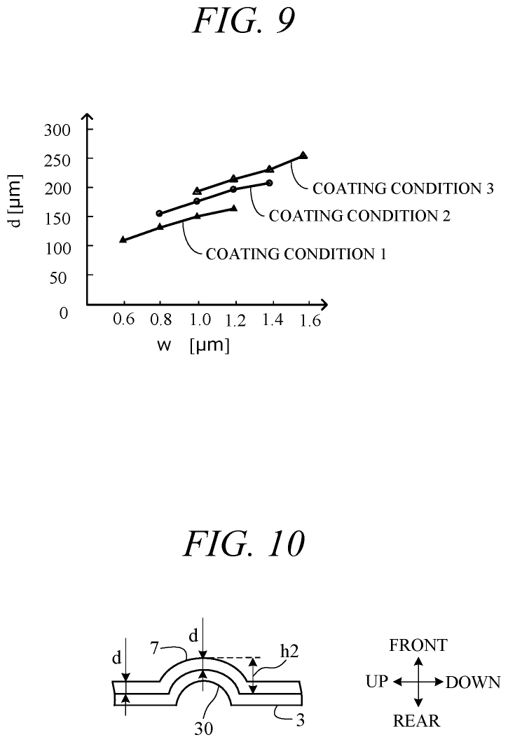

FIG. 8 is a cross-sectional view of the sealing member 7 coated on the surface of the separator 3, and FIG. 9 is a diagram for describing characteristics (thixotropic characteristics) of the resin material constituting the sealing member 7. As illustrated in FIGS. 8 and 9, in a case where coating conditions such as the composition of the paste P are the same, a thickness d of the sealing member 7 made of a resin material having thixotropy after curing is determined according to a width w of the portion in contact with the surface of the separator 3. That is, as the width w of the sealing member 7 is larger (wider), the thickness d of the sealing member 7 is larger (higher), and as the width w of the sealing member 7 is smaller (narrower), the thickness d of the sealing member 7 is smaller (lower). The width w of the sealing member 7 corresponds to the width w of the groove portion 13 of the jig 10A, that is, the width w between the pair of dividing surfaces 113 and 113 of the jig body 11.

FIG. 10 is a cross-sectional view of the sealing member 7 coated by the jig 10A, and FIG. 11 is a perspective view of the sealing member 7 coated by the jig 10A. As illustrated in FIGS. 10 and 11, the width w and the thickness d of the sealing member 7 coated by the jig 10A are uniform in the extension direction of the sealing member 7. Since the sealing member 7 extends along the surface of the separator 3 including the protrusion 30, a height h2 of the sealing member 7 from the surface of the separator 3 is higher at a position where the sealing member 7 crosses the protrusion 30 than the other positions by the height of the protrusion 30.

As described above, in a case where the height h2 of the sealing member 7 from the surface of the separator 3 varies, the linear pressure (seal load) applied to the distal end of the sealing member 7 in close contact with the electrode assembly 2 (frame 21) in FIG. 3 varies in the extension direction of the sealing member 7 in FIG. 4, and leakage may occur at a place where the linear pressure is low. Note that the linear pressure is an average value per unit length of the surface pressure applied to the distal end of the sealing member 7 in close contact with the electrode assembly 2 (frame 21), in the extension direction of the sealing member 7 by the compressive load.

### Second Embodiment

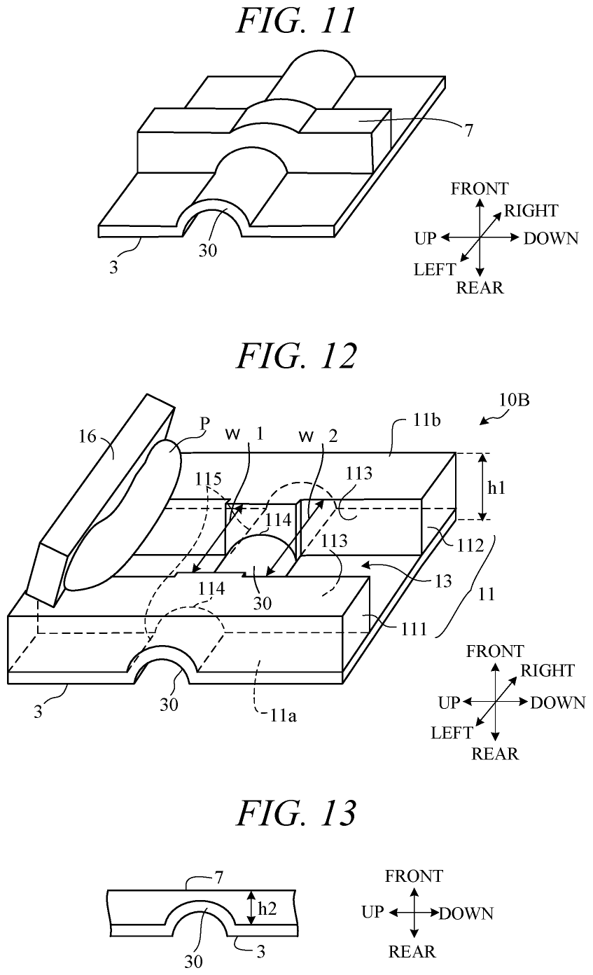

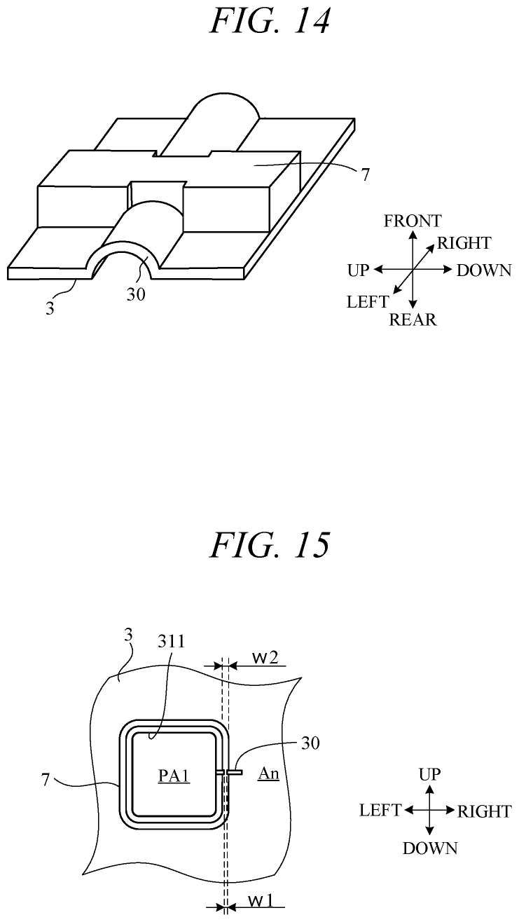

FIG. 12 is a perspective view partially illustrating a jig 10B according to a second embodiment of the present invention, FIG. 13 is a cross-sectional view of the sealing member 7 coated by the jig 10B, and FIG. 14 is a perspective view of the sealing member 7 coated by the jig 10B. To describe the difference from the first embodiment, the jig 10B is configured such that the width w (the width w of the groove portion 13) between the pair of dividing surfaces 113 and 113 of the jig body 11 is narrowed at a position corresponding to the recess 115. More specifically, as illustrated in FIG. 12, a width w1 of the groove portion 13 at the position corresponding to the recess 115 is set to a value smaller than a width w2 of the groove portion 13 at the other positions (w1<w2).

In this case, as illustrated in FIGS. 13 and 14, the height h2 of the sealing member 7 coated by the jig 10B from the surface of the separator 3 is uniform in the extension direction of the sealing member 7. That is, the width w1 of the sealing member 7 at the position where the sealing member 7 crosses the protrusion 30 is smaller than the width w2 of the sealing member 7 at the other positions, and the thickness d of the sealing member 7 is smaller at the position where the sealing member 7 crosses the protrusion 30 than at the other positions. Thus, the height h2 of the sealing member 7 from the surface of the separator 3 becomes uniform in the extension direction of the sealing member 7, and the variation in the linear pressure (seal load) applied to the distal end of the sealing member 7 in close contact with the electrode assembly 2 (frame 21) of FIG. 3 is eliminated, and the sealing properties is improved.

The widths w1 and w2 of the sealing member 7 and the groove portion 13 of the jig 10B are set according to the maximum pressure of the gas flowing through the gas flow path, the material of the sealing member 7, the compressive load applied to the sealing member 7, and the like. The ratio between the width w1 and the width w2 may be determined on the basis of the coating position of the sealing member 7 on the surface of the separator 3, the shape of the protrusion 30, the characteristics of the resin material illustrated in FIG. 9, and the like, or may be determined by trial production of the jig 10B (jig body 11) and the sealing member 7.

FIG. 15 is a front view illustrating an example of the sealing structure of the plate-shaped member according to the second embodiment, and illustrates the sealing structure in the vicinity of the through-hole 311 (fuel gas supply flow path PA1) of the separator (anode separator) 3 facing the electrode assembly 2 (frame 21). As illustrated in FIG. 15, the sealing structure of the plate-shaped member includes the separator 3 having the protrusion 30, and the sealing member 7 provided on the surface of the separator 3 to cross the protrusion 30. The height h2 of the sealing member 7 from the surface of the separator 3 is uniform, and the width w (w1, w2) of the sealing member 7 is narrowed at a position where the sealing member 7 crosses the protrusion 30.

As described above, in the second embodiment, unlike the first embodiment, the jig 10B is configured such that the width w (the width w of the groove portion 13) between the pair of dividing surfaces 113 and 113 of the jig body 11 is narrowed at the position corresponding to the recess 115, and thus the sealing member 7 having a uniform height can be formed. In addition, since the height h1 of the groove portion 13 of the jig 10B is uniform, the sealing member 7 along the shape of the groove portion 13 can be formed by single screen coating using the squeegee 16 as in the first embodiment.

According to the present embodiment, the following effects can be achieved.
(1) The jig 10B for screen-coating, with the sealing member 7, the surface of the separator 3 having the protrusion 30 to cross the protrusion 30 includes the jig body 11 (FIG. 12). The jig body 11 has higher rigidity than that of the sealing member 7. The jig body 11 is to be placed on the surface of the separator 3. The jig body 11 has the first surface 11a facing the surface of the separator 3, the second surface 11b on a side opposite to the first surface 11a, and the pair of dividing surfaces 113 and 113 that extends from the first surface 11a to the second surface 11b and divides at least a part of the jig body 11 into the first portion 111 and the second portion 112. The first surface 11a has the recesses 115 and 115 to be fitted to the protrusions 30 of the separator 3 starting from intersection portions 114 and 114 with the pair of dividing surfaces 113 and 113. The pair of dividing surfaces 113 and 113 has a uniform height h1 from the first surface 11a to the second surface 11b, and the width w between the pair of dividing surfaces 113 and 113 is narrowed at the position corresponding to the recesses 115 and 115.

As described above, by providing the recess 115 fitted to the protrusion 30 on the surface of the separator 3, displacement of the jig body 11 with respect to the coating surface can be restricted during the coating, and screen coating can be accurately performed on the surface of the separator 3. In addition, by performing the screen coating using the jig body 11 having relatively higher rigidity than that of the sealing member 7, it is possible to prevent the sealing member 7 from being applied to the outside of the groove portion 13 and to coat and form the sealing member 7 having a shape conforming to the shape of the groove portion 13. Further, by making the depth (height) h1 of the groove portion 13 uniform, the sealing member 7 can be formed by single screen coating using the squeegee 16. Furthermore, by narrowing the width w of the groove portion 13 at the position corresponding to the recess 115 fitted to the protrusion 30 on the surface of the separator 3, it is possible to prevent the sealing member 7 from swelling at the position where the sealing member 7 crosses the protrusion 30 and to form the sealing member 7 having a uniform height h2.
(2) The protrusion 30 has a curved cross-sectional shape, for example, a semi-cylindrical shape (FIG. 12). Even in a case where the protrusion 30 is curved and the sealing member 7 coated on the protrusion 30 is likely to spread, by narrowing the widths w of the groove portion 13 and the sealing member 7 at the position where the sealing member 7 crosses the protrusion 30, it is possible to prevent swelling at the position where the sealing member 7 crosses the protrusion 30 and to form the sealing member 7 having a uniform height h2.
(3) The pair of dividing surfaces 113 and 113 surrounds one of the first portion 111 and the second portion 112 (FIG. 12). The jig 10B further includes the connection portion 12 that connects the first portion 111 and the second portion 112. Even in a case where the pair of dividing surfaces 113 and 113 (groove portion 13) is provided in an annular shape and the jig body 11 is completely divided, the screen coating can be accurately performed by providing the connection portion 12.
(4) The sealing member 7 is a resin member. Even in a case where the sealing member 7 is coated through the groove portion 13 of the jig 10, the aspect ratio between the width w and the thickness d after curing is determined by the thixotropy of the resin material. In consideration of such characteristics, the height h2 of the cured sealing member 7 from the surface of the separator 3 can be made uniform by narrowing the width w at the position where the sealing member 7 crosses the protrusion 30 of which the thickness d should be reduced.
(5) The sealing structure of the plate-shaped member includes the separator 3 having the protrusion 30, and the sealing member 7 provided on the surface of the separator 3 to cross the protrusion 30 (FIGS. 13 to 15). The height h2 of the sealing member 7 from the surface of the separator 3 is uniform, and the width w of the sealing member 7 is narrowed at a position where the sealing member 7 crosses the protrusion 30. In a case where the sealing member 7 is used to form the sealed space to face the plate-shaped member such as the separator 3 having the protrusion 30, the sealing properties of the sealed space can be secured by making the height h2 of the sealing member 7 uniform.

In the above embodiments, the screen coating jig for screen-coating the surface of the separator 3 of the fuel cell with the sealing member 7 to cross the protrusion 30 forming the gas communication path and the sealing structure of the separator 3 have been described as an example, but the screen coating jig and the sealing structure of the plate-shaped member are not limited thereto. The protrusion may be any protrusion as long as the protrusion protrudes from the surface of the plate-shaped member on which the sealing member is applied, and is not limited to a hollow protrusion that forms a communication path for gas or the like. The sealing member may cross the protrusion, and the extension direction of the protrusion and the extension direction of the sealing member do not need to be orthogonal to each other. The surface of the plate-shaped member only needs to have the protrusion and a portion other than the protrusion, and the area occupied by the protrusion is not required to be smaller than the area occupied by the portion other than the protrusion. For example, the present invention can also be applied to a plate-shaped member having a recess such as a groove in a part by regarding the portion other than the recess as the protrusion. In this case, it is possible to form the sealing member having a uniform height by configuring the width of the sealing member to be wide at a position where the sealing member crosses the recess of such a plate-shaped member and configuring the width between the pair of dividing surfaces of the jig body to be wide at a position corresponding to the protrusion fitted to the recess of such a plate-shaped member.

The above embodiment can be combined as desired with one or more of the aforesaid modifications. The modifications can also be combined with one another.

According to the present invention, it becomes possible to form a uniform height sealing member.

Above, while the present invention has been described with reference to the preferred embodiments thereof, it will be understood, by those skilled in the art, that various changes and modifications may be made thereto without departing from the scope of the appended claims.

1. A screen coating jig for screen-coating a surface of a plate-shaped member having a protrusion to cross the protrusion with a sealing member, comprising:
a jig body having higher rigidity than the sealing member to be placed on the surface of the plate-shaped member, wherein
the jig body includes:
a first surface facing the surface of the plate-shaped member;
a second surface on an opposite side of the first surface; and
a pair of dividing surfaces extending from the first surface to the second surface and dividing at least a part of the jig body into a first portion and a second portion, wherein
the first surface includes a recess to be fitted to the protrusion of the plate-shaped member starting from intersection portions with the pair of dividing surfaces, wherein
the pair of dividing surfaces has a uniform height from the first surface to the second surface, wherein
a width between the pair of dividing surfaces is narrowed at a position corresponding to the recess.

2. The screen coating jig according to claim 1, wherein
the protrusion has a curved cross-sectional shape.

3. The screen coating jig according to claim 1, wherein
the pair of dividing surfaces surrounds one of the first portion and the second portion, wherein
the screen coating jig further comprises:
a connection portion configured to connect the first portion and the second portion.

4. The screen coating jig according to claim 3, wherein
the pair of dividing surfaces is provided in an annular shape.

5. The screen coating jig according to claim 1, wherein
the sealing member is a resin member.

6. The screen coating jig according to claim 5, wherein
a ratio between the width at a position corresponding to the recess and the width at other position is determined based on thixotropy of the resin material.

7. The screen coating jig according to claim 1, wherein
the protrusion is a hollow member forming a communication path for fluid on the surface of the plate-shaped member.

8. A sealing structure of a plate-shaped member, comprising:
a plate-shaped member having a protrusion; and
a sealing member provided on a surface of the plate-shaped member to cross the protrusion, wherein
the sealing member has a uniform height from the surface of the plate-shaped member, wherein
a width of the sealing member is narrowed at a position where the sealing member crosses the protrusion.
